(19) United States
(12) Patent Application Publication
(10) Pub. No.: US 2009/0016626 A1
(43) Pub. Date: Jan. 15, 2009

(54) JOINT CODING OF MULTIPLE TRANSFORM BLOCKS WITH REDUCED NUMBER OF COEFFICIENTS

(75) Inventors: Cixun Zhang, Tampere (FI); Kemal Ugur, Tampere (FI); Jani Lainema, Tampere (FI); Antti Olli Hallapuro, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/138,333

(22) Filed: Jun. 12, 2008

Related U.S. Application Data
(60) Provisional application No. 60/943,466, filed on Jun. 12, 2007.

(51) Int. Cl. G06K 9/36

(52) U.S. Cl. 382/238; 375/240.24

(57) ABSTRACT

A system and method for video/image encoding and decoding, where transform coefficients associated with a plurality of blocks are reorganized and coded together. Various embodiments perform transform and quantization and generate transform coefficients, where the coefficients of the transform blocks are reorganized and interleaved. Additionally, an encoding process involves coding only a subset of the transform coefficients belonging to the transform blocks resulting in one or more transform blocks less than the original number of transform blocks, and putting this into a bitstream. A decoding process involves decoding the one or more resulting transform blocks including the subset of transform coefficients from the bistream, the transform coefficients being put in an array and decoded. The decoder de-interleaves the decoded transform coefficients and any remaining coefficients of the one or more transform blocks are filled in according to a plurality of different methods. After the one or more transform blocks are fully decoded, inverse transform and inverse quantization are performed and residual data is generated.

### FIELD OF THE INVENTION

The present invention relates to the coding and decoding of digital video and image material. More particularly, the present invention relates to the efficient coding and decoding of transform coefficients in video and image coding.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video codec comprises an encoder that transforms input video into a compressed representation suited for storage and/or transmission and a decoder that can uncompress the compressed video representation back into a viewable form. Typically, the encoder discards some information in the original video sequence in order to represent the video in a more compact form, i.e., at a lower bitrate.

Conventional hybrid video codecs, for example ITU-T H.263 and H.264, encode video information in two phases. In a first phase, pixel values in a certain picture area or “block” are predicted. These pixel values can be predicted, for example, by motion compensation mechanisms, which involve finding and indicating an area in one of the previously coded video frames that corresponds closely to the block being coded. Additionally, pixel values can be predicted via spatial mechanisms, which involve using the pixel values around the block to estimate the pixel values inside the block. A second phase involves coding a prediction error, i.e., the difference between the predicted block of pixels and the original block of pixels. This is typically accomplished by transforming the difference in pixel values using a specified transform (e.g., a Discreet Cosine Transform (DCT) or a variant thereof), quantizing the transform coefficients, and entropy coding the quantized coefficients. By varying the fidelity of the quantization process, the encoder can control the balance between the accuracy of the pixel representation (i.e., the picture quality) and the size of the resulting coded video representation (i.e., the file size or transmission bitrate). It should be noted that with regard to video and/or image compression, it is possible to transform blocks of an actual image and/or video frame without applying prediction in to transform coefficients.

FIG. 1, for example, is a block diagram of a conventional video encoder. More particularly, FIG. 1 shows how an image to be encoded 100 undergoes pixel prediction 102, prediction error coding 103 and prediction error decoding 104. For pixel prediction 102, the image 100 undergoes both inter-prediction 106 and intra-prediction 108 which, after mode selection 110, results in a prediction representation of an image block 112. A preliminary reconstructed image 114 is also used for intra-prediction 108. Once all of the image blocks are processed, the preliminary reconstructed image 114 undergoes filtering at 116 to create a final reconstructed image 140, which is sent to a reference frame memory 118 and is also used for inter-prediction 106 of future frames.

The prediction representation of the image block 112, as well as the image to be encoded 100, are used together to define a prediction error signal 120 which is used for prediction error coding 103. In prediction error coding 103, the prediction error signal 120 undergoes transform 122 and quantization 124. The data describing prediction error and predicted representation of the image block 112 (e.g., motion vectors, mode information, and quantized transform coefficients) are passed to entropy coding 126. The prediction error decoding 104 is substantially the opposite of the prediction error coding 103, with the prediction error decoding including an inverse quantization 128 and an inverse transform 130. The result of the prediction error decoding 104 is a reconstructed prediction error signal 132, which is used in combination with the predicted representation of the image block 112 to create the preliminary reconstructed image 114.

The decoder reconstructs output video by applying prediction mechanisms that are similar to those used by the encoder in order to form a predicted representation of the pixel blocks (using motion or spatial information created by the encoder and stored in the compressed representation). Additionally, the decoder utilizes prediction error decoding (the inverse operation of the prediction error coding, recovering the quantized prediction error signal in the spatial pixel domain). After applying the prediction and prediction error decoding processes, the decoder sums up the prediction and prediction error signals (i.e., the pixel values) to form the output video frame. The decoder (and encoder) can also apply additional filtering processes in order to improve the quality of the output video before passing it on for display and/or storing it as a prediction reference for the forthcoming frames in the video sequence.

FIG. 2, for example, is a block diagram of a conventional video decoder. As shown in FIG. 2, entropy decoding 200 is followed by both prediction error decoding 202 and pixel prediction 204. In prediction error decoding 202, an inverse quantization 206 and inverse transform 208 is used, ultimately resulting in a reconstructed prediction error signal 210. For pixel prediction 204, either intra-prediction or inter-prediction occurs at 212 to create a predicted representation of an image block 214. The predicted representation of the image block 214 is used in conjunction with the reconstructed prediction error signal 210 to create a preliminary reconstructed image 216, which in turn can be used for inter-prediction or intra-prediction at 212. Once all of the image blocks have been processed, the preliminary reconstructed image 216 is passed for filtering 218. The filtered image can either be output as a final reconstructed image 220, or the filtered image can be stored in reference frame memory 222, making it usable for prediction 212.

In conventional video codecs, motion information is indicated by motion vectors associated with each motion-compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, motion vectors are typically coded differentially with respect to block-specific predicted motion vectors. In a conventional video codec, the predicted motion vectors are created in a predefined way, for example by calculating the median of the encoded or decoded motion vectors of adjacent blocks.

Conventional video encoders utilize Lagrangian cost functions to find optimal coding modes, e.g., the desired macroblock mode and associated motion vectors, where a macroblock comprises a block of 16×16 pixels. This kind of cost function uses a weighting factor λ to tie together the exact or estimated image distortion due to lossy coding methods and the exact or estimated amount of information that is required to represent the pixel values in an image area:

C=D+λR (1)

In Eq. (1), C is the Lagrangian cost to be minimized, D is the image distortion (e.g., the mean squared error) with the mode and motion vectors considered, and R is the number of bits needed to represent the required data to reconstruct the image block in the decoder (including the amount of data to represent the candidate motion vectors).

Conventional video and image compression systems typically encode each block of transform coefficients independently. In certain scenarios, however, the independent coding of each block of transform coefficients is not efficient. Such inefficiency can result because not all coefficients (especially high frequency coefficients) in a block are valuable with regard to coding performance. In addition, other information, such as number and position of non-zero transform coefficients, is indicated for each block. For these reasons, the bitrate required to represent a coded signal unnecessarily increases.

Previous solutions exist which overcome the increase in required bitrate, such as a proposal entitled “Larger transform for residual signal coding” presented by G. Bjontegaard and A. Fuldseth, ITU-T Q.6/SG16, doc. VCEG-Y10, Hongkong, China, January 2005. This proposal is an International Telecommunication Union Telecommunication Standardization Sector (ITU-T) standards contribution, where a 16×16 transform is utilized for a 16×16 block. This proposal addresses the coding of flat regions with fewer coefficients. However, a small number of the 16×16 transform coefficients may be coded only in situations where only low frequency content is to be coded.

### SUMMARY OF THE INVENTION

Various embodiments of the present invention provide a system and method of video/image encoding and decoding, where transform coefficients associated with a plurality of blocks are reorganized and coded together. According to one embodiment, a macroblock can be divided into smaller transform blocks for encoding. A predicted image can be formed utilizing intra-prediction or inter-prediction, and an encoder performs transform and quantization on a prediction error signal and generates transform coefficients, where the coefficients of the transform blocks are interleaved into an array based on a predetermined interleaving technique. If no prediction is applied, the encoder performs transform and quantization on an actual image signal. Additionally, the encoder will only code a subset of the transform coefficients corresponding to each of the smaller transform blocks, and put this into the bitstream, where the reduction in the number of transform coefficients coded can be performed before, during, or after interleaving. Moreover, the resulting transform block(s) containing the subset of transform coefficients can be less than the original number of transform blocks into which the macroblock was divided. In the bitstream, the encoder can signal to the decoder that joint coding of multiple transform blocks with a reduced number of coefficients was used, in addition to other information including the scanning order of the transform coefficients, the interleaving method, and the number of transform coefficients used from each respective transform block.

In terms of decoding, a decoder receives an indication that joint coding of multiple transform blocks with a reduced number of coefficients was utilized in coding a relevant macroblock. The transform block(s) are decoded from the bitstream, the coefficients of which are put in an array, and decoded. The decoder de-interleaves the decoded coefficients, by separating each decoded coefficient into one of a plurality of transform blocks according to a predetermined de-interleaving method. Once the decoded coefficients have been de-interleaved, any remaining coefficients of the one or more transform blocks, i.e. coefficients which were discarded and not coded at the encoder level, are filled in according to a plurality of different methods. After the one or more transform blocks are fully decoded, inverse transform and inverse quantization are performed and residual data is generated. The ability of the various embodiments of the present invention to reduce the number of coefficients utilized in encoding improves the compression efficiency of video and image encoders. At the same time, the complexity of decoding in accordance with the various embodiments is reduced as well.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a block diagram of a conventional video encoder;

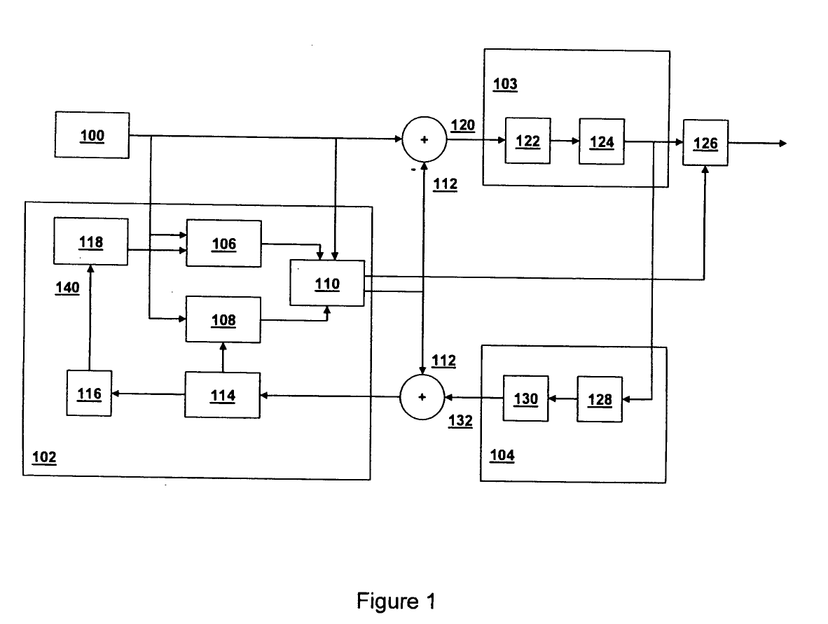

FIG. 2 is a block diagram of a conventional video decoder;

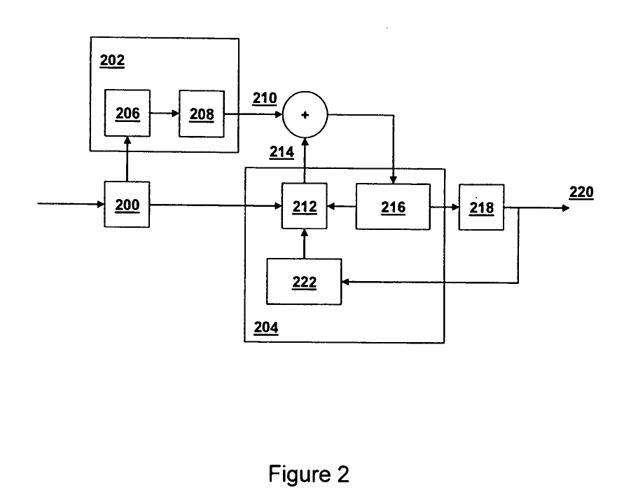

FIG. 3 is a block diagram of a video encoder constructed in accordance with one embodiment of the present invention;

FIG. 4 is a block diagram of a video decoder constructed in accordance with one embodiment of the present invention;

FIG. 5 is a block diagram of an image encoder constructed in accordance with one embodiment of the present invention;

FIG. 6 is a block diagram of an image decoder constructed in accordance with one embodiment of the present invention;

FIG. 7 illustrates a reorganization and interleaving process performed in accordance with one embodiment of the present invention;

FIG. 8 illustrates an inverse reorganization and de-interleaving process performed in accordance with one embodiment of the present invention;

FIG. 9 is an overview diagram of a system within which the present invention may be implemented;

FIG. 10 is a perspective view of a mobile telephone that can be used in the implementation of the present invention; and

FIG. 11 is a schematic representation of the telephone circuitry of the mobile telephone of FIG. 8.

### DETAILED DESCRIPTION OF VARIOUS EMBODIMENTS

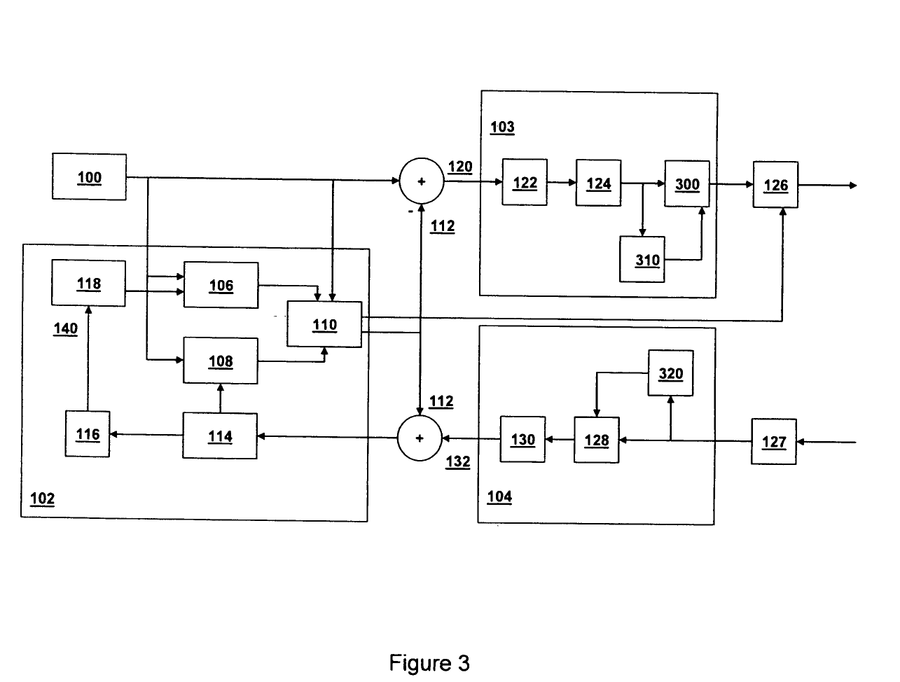

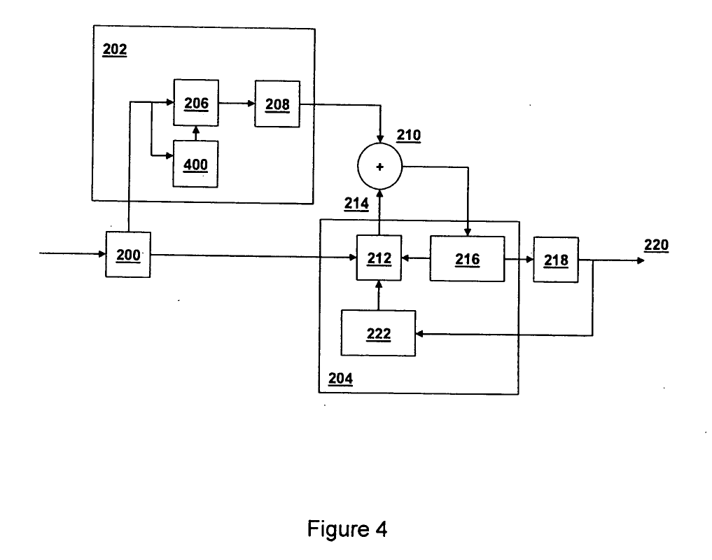

Various embodiments described herein improve the coding efficiency of a video/image coder by reorganizing the transform coefficients associated with a plurality of transform blocks, reducing the number of coefficients used from each transform block by zero or more and coding these transform coefficients together. Encoding and decoding processes performed in accordance with one embodiment of the present invention are illustrated in FIGS. 3 and 4, respectively. It should be noted that the processes illustrated in FIGS. 3 and 4 can apply to encoding and decoding the luminance component of the video signal, for example.

According to this embodiment, a 16×16 macroblock can be divided into four 8×8 transform blocks, although it should be noted that the various embodiments of the present invention are not limited to operating in solely accordance with these block/macroblock sizes. That is macroblocks of sizes other than 16×16 can be used and divided into transform blocks of sizes other than 8×8. For the encoding aspect, a predicted image can be formed utilizing a variety of methods, e.g., intra-prediction or inter-prediction. The encoder decides whether to code the 16×16 macroblock in accordance with the one embodiment of the present invention. If the encoder decides not to code the 16×6 macroblock in accordance with the one embodiment, a residual is formed conventionally by encoding the transform coefficients of the four 8×8 transform blocks after performing a transform and quantization. It should be noted that this and other embodiments of the present invention are not limited to coding 16×16 macroblocks, but can applied to picture areas of differing sizes.

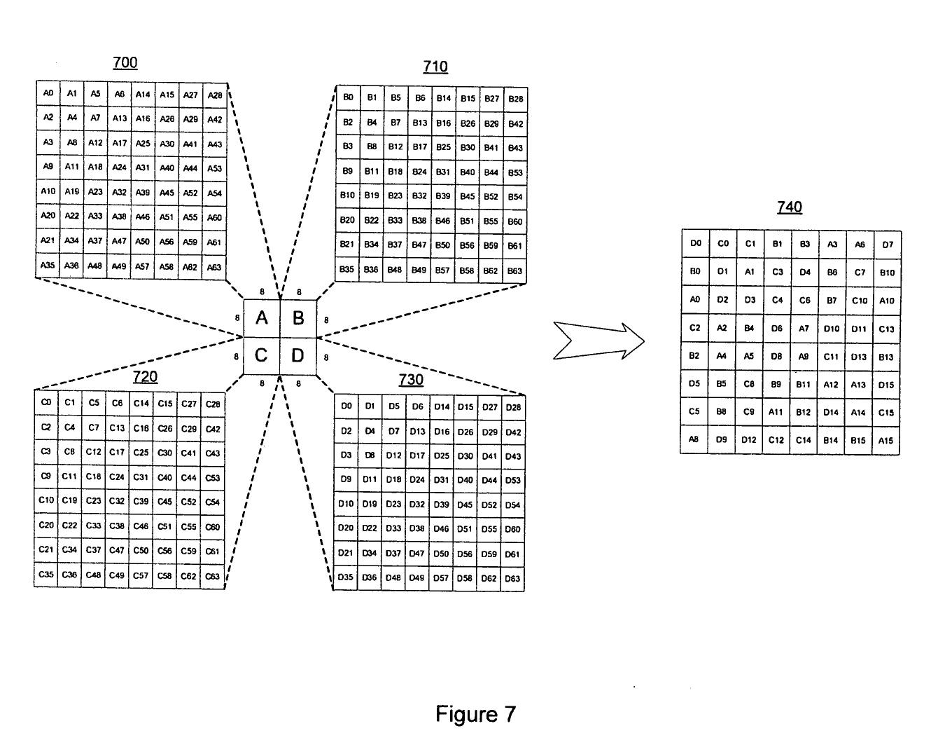

If the encoder does decide to code the 16×16 macroblock in accordance with the one embodiment, the encoder performs transform and quantization and generates transform coefficients. The coefficients of the four 8×8 transform blocks are then interleaved into an array based on a predetermined interleaving technique. One such technique for interleaving is illustrated in FIG. 7, which will be described in greater detail below. However, instead of encoding all of the coefficients for the four 8×8 transform blocks, the encoder codes some subset of the coefficients for each of the transform blocks and puts this into the bitstream. It should be noted that the order of encoding processes is not limited to that described above. It should also be noted that the number of coefficients comprising the subset of coefficients may be the same for all of the transform blocks (in this case, the four 8×8 transform blocks), or the number of coefficients coded from each of the transform blocks can be different. Hence the number of resulting transform blocks is smaller than the original four, in this case, one transform block.

More particularly with reference to FIG. 3, an image to be encoded 100 undergoes pixel prediction 102, prediction error coding 103 and prediction error decoding 104. For pixel prediction 102, the image 100 undergoes at least one of inter-prediction 106 and intra-prediction 108 which, after mode selection 110, results in a prediction representation of an image block 112. A preliminary reconstructed image 114 is also used for intra-prediction 108. Once all of the image blocks are processed, the preliminary reconstructed image 114 undergoes filtering at 116 to create a final reconstructed image 140, which is sent to a reference frame memory 118 and is also used for inter-prediction 106 of future frames.

The prediction representation of the image block 112, as well as the image to be encoded 100, are used together to define a prediction error signal 120 which is used for prediction error coding 103. In prediction error coding 103, the prediction error signal 120 undergoes transform 122 and quantization 124. However, unlike conventional video/image codecs, a mode decision is made at 300 after the prediction error signal 120 undergoes transform 122 and quantization 124. This mode decision 300 is made to determine whether or not the encoder will code a 16×16 macroblock in accordance with the one embodiment. It should be noted again that the macroblock can be of a different size, and if prediction is not applied, the mode decision 300 is made to determine whether or not the encoder will code an actual image or video block. After the mode decision is made at 300, the transform coefficients are reorganized and interleaved 310 according to the predetermined interleaving technique noted above and illustrated in FIG. 7. The reorganized and interleaved 8×8 transform block 740 of FIG. 7 is then passed to entropy coding 126, to be placed in the bitstream.

The prediction error decoding 104 is substantially the opposite of the prediction error coding 103. That is, upon entropy decoding at 127, the prediction error decoding 104 is executed, including an inverse reorganization and de-interleaving 320, an inverse quantization 128, and an inverse transform 130. The result of the prediction error decoding 104 is a reconstructed prediction error signal 132, which is used in combination with the predicted representation of the image block 112 to create the preliminary reconstructed image 114.

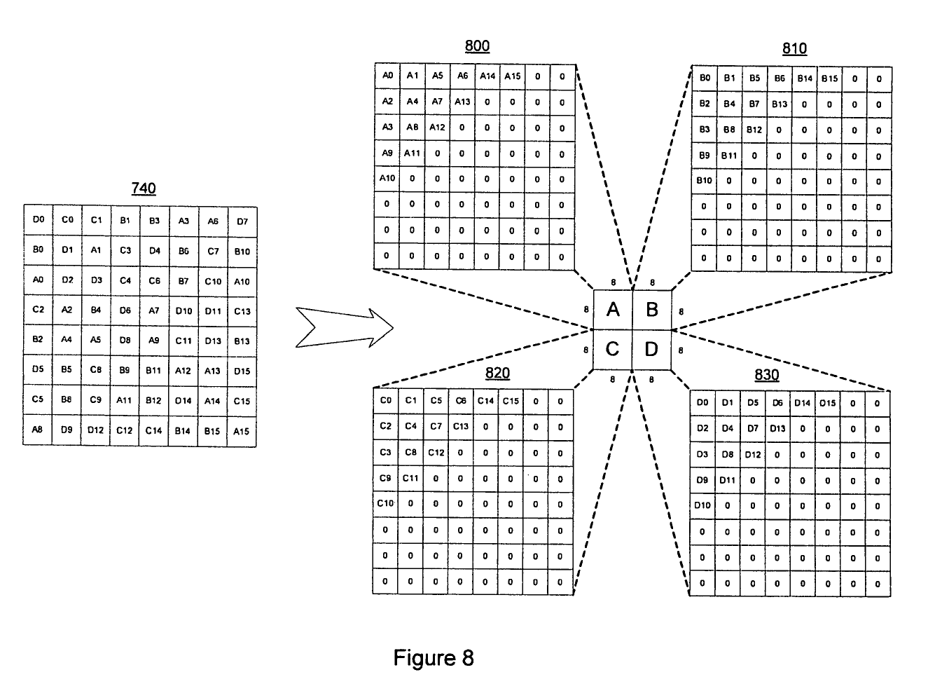

As to the decoding aspect of the one embodiment, prediction occurs according to at least one of intra-prediction and inter-prediction, resulting in a predicted representation of an image block. If the decoder receives an indication that the 16×16 macroblock, for example, is coded conventionally, a residual is formed by decoding coefficients of four transform blocks and performing inverse transform and inverse quantization. If on the other hand, the decoder receives an indication that joint coding of multiple transform blocks with a reduced number of coefficients was utilized in coding the 16×16 macroblock, the reduced number of coefficients of the transform blocks are decoded from the bitstream and put in an array. Following the example illustrated in FIG. 3, only one 8×8 resulting transform block is decoded. The decoder de-interleaves the decoded coefficients, by separating each decoded coefficient into one of the four 8×8 transform blocks according to a predetermined de-interleaving method (e.g., one that correlates to the above predetermined interleaving method utilized during encoding). Because a reduced number of coefficients was coded, the four 8×8 transform blocks each have zero or more coefficients missing. An example of such a predetermined de-interleaving method is illustrated at FIG. 8, which will be described in greater detail below. Once the decoded coefficients have been de-interleaved, any remaining coefficients of the one 8×8 transform block are filled in with predetermined values at the decoder level. This filling in process can comprise a plurality of different methods, although one example is to fill in the remaining coefficients with a value of zero as shown in FIG. 8. After the transform block is fully decoded, inverse transform and inverse quantization are performed and the residual data is generated. It should be noted that the decoding process described herein can follow an alternative order.

FIG. 4 is a block diagram illustrating in more detail, the decoding processes described above in accordance with the one embodiment of the present invention. As shown in FIG. 4, entropy decoding 200 is followed by both prediction error decoding 202 and pixel prediction 204. In prediction error decoding 202, an inverse quantization 206 and inverse transform 208 is used, ultimately resulting in a reconstructed prediction error signal 210. However, unlike conventional video/image decoders, upon receiving a notification that joint coding of multiple transform blocks with a reduced number of coefficients was utilized and before inverse quantization 206, the decoder decodes, for example, only the one resulting reorganized and interleaved 8×8 transform block (comprising the subset of coded transform coefficients) by undergoing inverse reorganization and de-interleaving 400. For pixel prediction 204, at least one of intra-prediction and inter-prediction occurs at 212 to create a predicted representation of an image block 214. The predicted representation of the image block 214 is used in conjunction with the reconstructed prediction error signal 210 to create a preliminary reconstructed image 216, which in turn can be used for inter-prediction or intra-prediction at 212. Once all of the image blocks have been processed, the preliminary reconstructed image 216 is passed on for filtering 218. The filtered image can either be output as a final reconstructed image 220, or the filtered image can be stored in reference frame memory 222, making it usable for prediction 212.

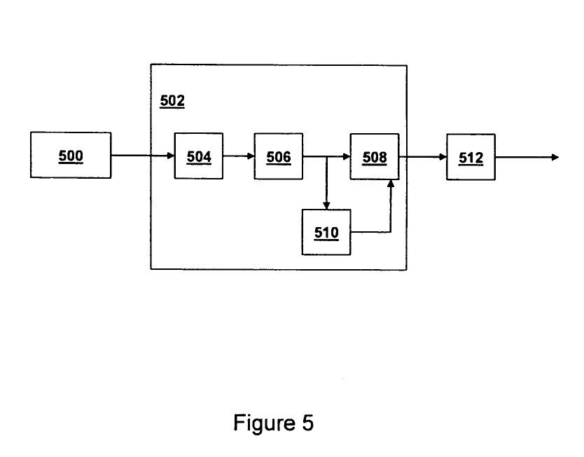

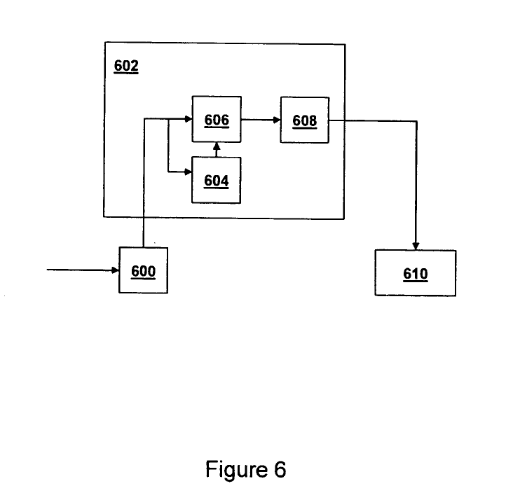

FIGS. 5 and 6 are block diagrams illustrating an image encoder and an image decoder, respectively, in accordance with an embodiment of the present invention. As shown in FIG. 5, an image to be encoded 500 undergoes texture coding 502. For texture coding 502, the image 500 undergoes transform 504 and quantization 506. Thereafter, a mode selection is made at 508 to determine whether or not the encoder will utilize joint coding of multiple transform blocks with a reduced number of coefficients. If so, the transform coefficients are reorganized and interleaved 510 according to a predetermined interleaving technique, such as that mentioned above and illustrated, for example, in FIG. 7. The reorganized and interleaved transform coefficients of the transform block 740 is then passed to entropy coding 512 for placement into a bitstream. Such a process can be utilized for still images or when prediction is not used and the actual video signal, for example, is to undergo transformation and quantization.

As shown in FIG. 6, entropy decoding 600 is followed by texture decoding 602. In texture decoding 602, a resulting transform block containing a subset of transform coefficients encoded, as for example, with the image encoder of FIG. 5, is subjected to inverse reorganization and de-interleaving 604. Upon the inverse reorganization and de-interleaving 604, inverse quantization 606 and inverse transformation 608 is performed to arrive at a reconstructed image 610. It should be noted that the image decoder diagrammed in FIG. 6 performs inverse reorganization and de-interleaving upon receipt, for example, of a notification or signal that joint coding of multiple transform blocks with a reduced number of coefficients was utilized.

As noted above, FIGS. 7 and 8 illustrate reorganization/interleaving and inverse reorganization/de-interleaving processes, respectively for use in accordance with various embodiments of the present invention. FIG. 7 illustrates a 16×16 macroblock which can be divided, after undergoing a transform, into four 8×8 transform blocks, e.g., blocks 700, 710, 720, and 730. The coefficients of transform block 700, for example, can be represented by A0, A1, A2, etc. Likewise, the coefficients of the transform block 710 can comprise coefficients B0, B1, B2, etc, the coefficients of the transform block 720 can comprise coefficients C0, C1, C2, etc., and the coefficients of the transform block 730 can comprise coefficients D0, D1, D2, etc.

Upon reorganization and interleaving of the respective coefficients of the transform blocks 700, 710, 720, and 730, a single transform block 740 can result. It should be noted again, that according to the various embodiments of the present invention, one or more blocks (but less than the original number of blocks) can be encoded into a bitstream and decoded from the bitstream. As described above, some predetermined manner of reorganization and interleaving can be utilized. In this case, block 740 comprises what can be described as a diagonal, zig-zag method. For example, the coefficients can be ordered beginning at the top left corner of the block 740 with coefficient D0. Coefficients C0, B0, A0, D1, C1, B1, A1, D2, C2, etc. are then ordered in the diagonal, zig-zag manner until coefficient A15 encoded is ordered at the bottom, right-most corner of the block 740. Therefore, in this case, only coefficients A0 to A15, B0 to B15, C0 to C15, and D0 to D15 have been encoded.

FIG. 8 illustrates a inverse reorganization and de-interleaving process, where the one 8×8 transform block 740 is de-interleaved into four 8×8 blocks 800, 810, 820, and 830. As described above, only the first fifteen coefficients of transform blocks 700, 710, 720, and 730 have been encoded. Therefore, transform block 800 contains decoded coefficients A0 to A15, transform block 810 contains decoded coefficients B0 to B15, transform block 820 contains decoded coefficients C0 to C15, and transform block 830 contains decoded coefficients D0 to D15. Again, the coefficients are ordered in a diagonal, zig-zag manner, where the first of each set of coefficients, e.g., A0, B0, C0, and D0 are set at the upper, left-most corner of their respective transform blocks 800, 810, 820, and 830. It should be noted that the remaining coefficients can be set/filled to a predefined number, for example, zero. As described above, not all coefficients in a block are valuable in terms of coding performance and can thus be disregarded.

It should also be noted that the above encoding and decoding processes can be extended to encompass the chrominance components of a video signal, for example. According to another embodiment of the present invention, U and V chrominance components of the YUV color space can be interleaved together. Therefore, the coefficients of multiple blocks can be coded in a compact/efficient manner using only a subset of the total coefficients. At the same time, various embodiments of the present invention can be utilized to code other information, such as an end-of-block indication, an indication of all-zero coefficient in the block, etc., where the coding occurs only once as opposed to multiple times for multiple blocks. Hence, the overall bitrate can be reduced in certain cases.

As described above, one embodiment of the present invention allows a video decoder to receive a coded prediction error signal, decode transform coefficients associated with one or more transform blocks, reorganize those coefficients to recover coefficients associated with each transform block, and reconstruct the prediction error blocks. However, a video/image encoder and/or decoder according to the present invention can be implemented in a plurality of other ways. For example, the blocks used in the interleaving/de-interleaving process can belong to the same or different components, for example, of the YUV color space, e.g., the Y (luma) component or the U and V components, respectively. Alternatively, the blocks used in the interleaving/de-interleaving process can belong to the same macroblock or different (e.g., adjacent) macroblocks. Furthermore, the various embodiments of the present invention can be utilized to code both inter-residual data and intra-residual data.

According to other embodiments of the present invention, different interleaving/de-interleaving processes applied to the coefficients of multiple blocks can be used. With regard to one such other embodiment, the order of each block in an interleaving/de-interleaving process can be different. For example, the order of each block in a interleaving/de-interleaving process can depend on other characteristics of the coded representation or the decoded signal. Another example arises with regard to intra-coding, where the order of each block in an interleaving process can be associated with an intra-prediction mode for each block. As to inter-coding, the order of each block can be associated, for example, with the sizes and shapes of motion blocks within the macroblock to be coded. Yet another example arises when the order of each block in a interleaving/de-interleaving process is signaled.

Still another example of an interleaving/de-interleaving process comprises utilizing different scanning techniques in the interleaving/de-interleaving process. For example, according to an embodiment of the present invention, all blocks are interleaved/de-interleaved using a zig-zag scan, such as that described above in FIGS. 5 and 6. In another embodiment, the scan direction can depend on characteristics of the coded representation or the decoded signal. In other words, for intra-coding, the scan order of different blocks can be associated with the intra-prediction mode for each block. For inter-coding, the scan order of each block can be associated, for example, with the sizes and shapes of motion blocks within the macroblock to be coded. In yet another embodiment, the scan direction can be signaled.

After a de-interleaving process, other embodiments can be implemented, where the decoder can fill the remaining coefficients according to various methods. For example, the remaining coefficients can be set to a pre-defined number, like zero, as described above and illustrated in FIG. 6. Alternatively, the remaining coefficients can be set to a pre-defined pattern involving one's and zero's (or any other possible combination). According to yet another aspect of the present invention, the filling process can be signaled.

Like the order of blocks that can be different, the order of coefficients in each block can be different as well. For example, the order of coefficients in each block can be signaled or can depend on other characteristics of the coded representation or the decoded signal. For example, with regard to intra-coding, the order of coefficients in each block can be associated with the intra-prediction mode for each block, and for inter-coding, the order of coefficients can be associated, for example, with the sizes and shapes of motion blocks within the macroblock to be coded.

Yet another aspect of the present invention that can be varied according to different embodiments involves the same or different number of coefficients in different blocks that can be selected in an interleaving process. For example, the number of coefficients can be pre-defined or the number of coefficients can be associated with the residual of each block. The number of coefficients can also depend on other characteristics of the coded representation or the decoded signal, e.g., the coding mode of the blocks with regard to intra-coding, the number of coefficients in each block can be associated with the intra-prediction mode for each block. Alternatively, if the various embodiments of the present invention are utilized for coding inter-residual data, the number of coefficients can depend on the shapes and sizes of the motion blocks.

Lastly, the various embodiments of the present invention can be varied, where coefficients or the prediction error of coefficients in different blocks can be used in interleaving/de-interleaving processes.

Hence, the various embodiments of the present invention improve the compression efficiency of video and image encoders and decoders. At the same time, the complexity of decoding in accordance with the various embodiments is reduced. Although the computational complexity of encoding may be increased, fast algorithms can be applied in order to reduce the encoding complexity.

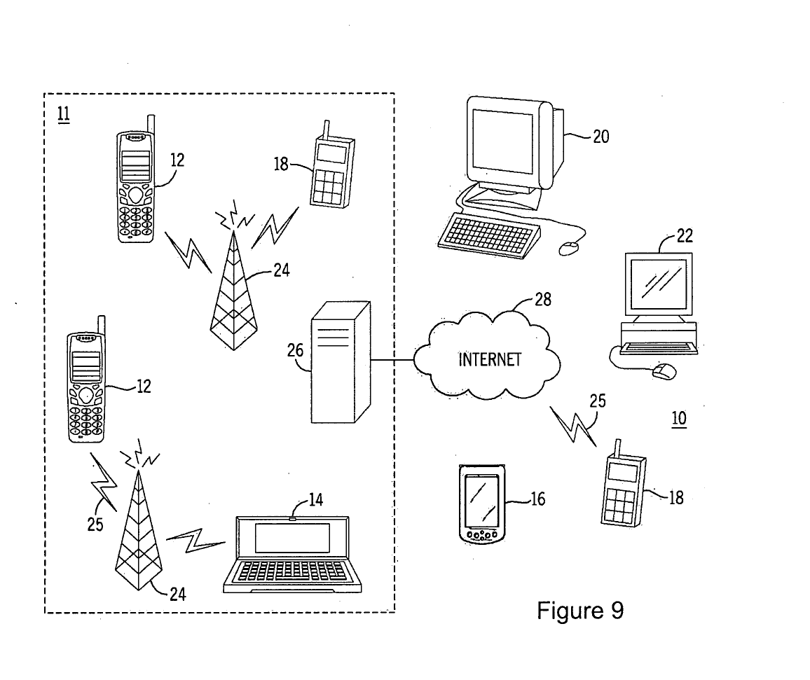

FIG. 9 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 9 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 50, a combination personal digital assistant (PDA0 and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

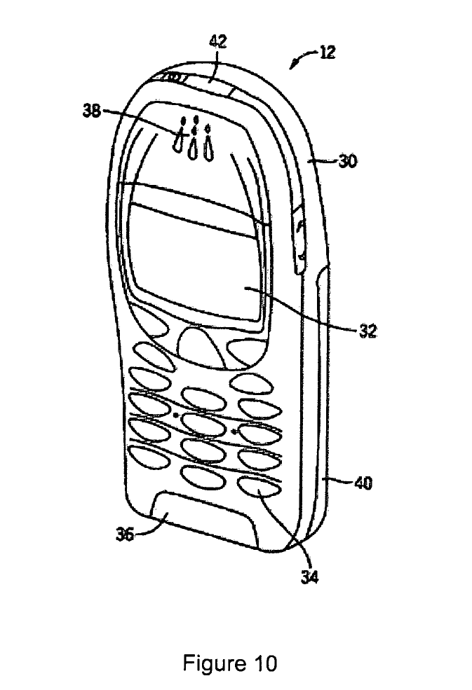

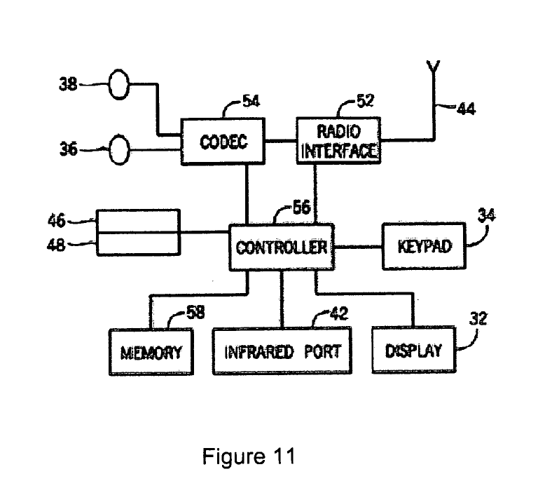

FIGS. 10 and 11 show one representative electronic device 50 within which the present invention may be implemented. It should be understood, however, that the present invention is not intended to be limited to one particular type of device. The electronic device 50 of FIGS. 10 and 11 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The various embodiments of the present invention described herein is described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated.

What is claimed is:

1. A method of encoding at least one of a video and animage signal, comprising:
transform coding a signal into a plurality of transform blocks;
quantizing transform coefficients of the plurality of transform blocks;
reorganizing and interleaving the transform coefficients of the plurality of transform blocks; and
entropy encoding a subset of the interleaved transform coefficients.

2. The method of claim 1, wherein the reorganizing and the interleaving comprises an ordering technique applied to each of the plurality of transform blocks.

3. The method of claim 2, wherein the ordering technique comprises at least one of a different ordering applied to each of the plurality of transform blocks, a dependent ordering based upon characteristics of one a coded and decoded representation of an image associated with the signal, a dependent ordering based upon a coding mode of at least one of the plurality of transform blocks, a dependent ordering based upon an intra-prediction mode associated with at least one of the plurality of transform blocks, a dependent ordering based upon shapes and sizes of motion blocks corresponding to a large block representative of the signal, and a signaled order.

4. The method of claim 1, wherein the reorganizing and the interleaving comprises a scanning technique applied to each of the plurality of transform blocks.

5. The method of claim 4, wherein the scanning technique comprises at least one of zig-zag scanning technique, a dependent scanning technique based upon characteristics of one a coded and decoded representation of an image associated with the signal, a dependent scanning technique based upon a coding mode of at least one of the plurality of transform blocks, a dependent scanning technique based upon an intra-prediction mode associated with at least one of the plurality of transform blocks, a dependent scanning technique based upon shapes and sizes of motion blocks corresponding to a macroblock representative of the signal, and a signaled scan direction.

6. The method of claim 1, wherein an order of the transform coefficients is at least one of a different order for each of the plurality of transform blocks, the order based upon characteristics of one of a coded and decoded representation of an image associated with the signal, a dependent order based upon a coding mode of at least one of the plurality of transform blocks, a dependent order based upon an intra-prediction mode associated with at least one of the plurality of transform blocks, a dependent order based upon shapes and sizes of motion blocks corresponding to a macroblock representative of the signal, and a signaled order.

7. The method of claim 1, wherein a same number of transform coefficients from each of the plurality of transform blocks is selected for encoding, the same number being one of a predefined number, a number based upon characteristics of one of a coded and decoded representation of an image associated with the signal, a number based upon a coding mode of at least one of the plurality of transform blocks, a number dependent on an intra-prediction mode associated with at least one of the plurality of transform blocks and a number based upon shapes and sizes of motion blocks corresponding to a macroblock representative of the signal.

8. The method of claim 1, where a different number of coefficients from each of the plurality of transform blocks is selected for encoding, the same number being one of a predefined number, a number based upon characteristics of one of a coded and decoded representation of an image associated with the signal, a number based upon a coding mode of at least one of the plurality of transform blocks, a number dependent on an intra-prediction mode associated with at least one of the plurality of transform blocks and a number based upon shapes and sizes of motion blocks corresponding to a macroblock representative of the signal.

9. The method of claim 1, wherein the signal is either intra or inter prediction error.

10. The method of claim 1, wherein each of the plurality of transform blocks belongs to one of a single component, different components, a single macroblock, and different macroblocks.

11. The method of claim 1, further comprising signaling a filling process to be performed by a decoder after inverse reorganization and de-interleaving for reconstructing the transform coefficients.

12. The method of claim 1, wherein the signal comprises one of inter-residual data, intra-residual data, a prediction error signal, an actual video signal when no prediction is made and an actual image signal when prediction is not applied.

13. A computer program product, embodied on a computer-readable medium, comprising computer code configured to perform the processes of claim 1.

14. An apparatus, comprising:
a processor; and
a memory unit communicatively connected to the processor and including:
computer code configured to transform code a signal into a plurality of transform blocks;
computer code configured to quantize transform coefficients of the plurality of transform blocks;
computer code configured to reorganize and interleave the transform coefficients of the plurality of transform blocks; and
computer code configured to encode a subset of the transform coefficients of the plurality of transform blocks, to allow placement of the subset of the transform coefficients into a bitstream.

15. The apparatus of claim 14, wherein the computer code configured to reorganize and interleave further comprises an ordering technique applied to each of the plurality of transform blocks.

16. The apparatus of claim 14, wherein the computer code configured to reorganize and interleave further comprises a scanning technique applied to each of the plurality of transform blocks.

17. The apparatus of claim 14, wherein an order of the transform coefficients is at least one of a different order for each of the plurality of transform blocks, the order based upon characteristics of one of a coded and decoded representation of an image associated with the signal, a dependent ordering based upon a coding mode of at least one of the plurality of transform blocks, a dependent ordering based upon an intra-prediction mode associated with at least one of the plurality of transform blocks, a dependent ordering based upon shapes and sizes of motion blocks corresponding to a large block representative of the signal, and a signaled order.

18. The apparatus of claim 14, wherein a same number of coefficients from each of the plurality of transform blocks is selected for encoding, the same number being one of a predefined number, a number based upon characteristics of one of a coded and decoded representation of an image associated with the signal, a number based upon a coding mode of at least one of the plurality of transform blocks, a number dependent on an intra-prediction mode associated with at least one of the plurality of transform blocks and a number based upon shapes and sizes of motion blocks corresponding to a macroblock representative of the signal.

19. The apparatus of claim 14, where a different number of coefficients from each of the plurality of transform blocks is selected for encoding, the same number being one of a predefined number, a number based upon characteristics of one of a coded and decoded representation of an image associated with the signal, a number based upon a coding mode of at least one of the plurality of transform blocks, a number dependent on an intra-prediction mode associated with at least one of the plurality of transform blocks and a number based upon shapes and sizes of motion blocks corresponding to a macroblock representative of the signal.

20. The method of claim 14, wherein the memory unit further comprises computer code configured to signal a filling process to be performed by a decoder after inverse reorganization and de-interleaving for reconstructing the transform coefficients.

21. The apparatus of claim 14, wherein each of the plurality of transform blocks belongs to one of a single component, different components, a single macroblock, and different macroblocks.

22. A method of decoding at least one of a video and an image signal, comprising:
decoding transform coefficients from a coded bitstream, the transform coefficients comprising a subset of transform coefficients from a plurality of transform blocks, each of the plurality of transform blocks representing a corresponding transformed portion of a signal;
performing inverse reorganizing and de-interleaving of the decoded transform coefficients;
filling remaining coefficients of each of the plurality of transform blocks according to a predetermined fill process; and
performing inverse quantization and inverse transformation to reconstruct the plurality of transform blocks.

23. The method of claim 22, wherein the inverse reorganizing and the de-interleaving comprises an ordering technique applied to each of the plurality of transform blocks.

24. The method of claim 23, wherein the ordering technique comprises at least one of a different ordering applied to each of the plurality of transform blocks, a dependent ordering based upon characteristics of one of a coded and decoded representation of an image associated with the signal, a dependent ordering based upon a coding mode of at least one of the transform blocks, a dependent ordering based upon an intra-prediction mode associated with at least one of the plurality of transform blocks, a dependent ordering based upon shapes and sizes of motion blocks corresponding to a macroblock representative of the signal, and a signaled order.

25. The method of claim 22, wherein the inverse reorganizing and the de-interleaving comprises a scanning technique applied to each of the plurality of transform blocks.

26. The method of claim 25, wherein the scanning technique comprises at least one of zig-zag scanning technique, a dependent scanning technique based upon a coding mode of at least one of the plurality of transform blocks, a dependent scanning technique based upon an intra-prediction mode associated with at least one of the plurality of transform blocks, and a dependent scanning technique based upon shapes and sizes of motion blocks corresponding to a large block representative of the signal.

27. The method of claim 22, wherein an order of the transform coefficients is at least one of a different order for each of the plurality of transform blocks, the order based upon characteristics of one of a coded and decoded representation of an image associated with the signal, a dependent order based upon a coding mode of at least one of the plurality of transform blocks, a dependent order based upon an intra-prediction mode associated with at least one of the plurality of transform blocks, a dependent order based upon shapes and sizes of motion blocks corresponding to a macroblock representative of the signal, and a signaled order.

28. The method of claim 22, wherein a same number of coefficients from each of the plurality of transform blocks is selected for encoding, the same number being one of a predefined number, a number based upon characteristics of one of a coded and decoded representation of an image associated with the signal, a number based upon a coding mode of at least one of the plurality of transform blocks, a number dependent on an intra-prediction mode associated with at least one of the plurality of transform blocks and a number based upon shapes and sizes of motion blocks corresponding to a macroblock representative of the signal.

29. The method of claim 22, where a different number of coefficients from each of the plurality of transform blocks is selected for encoding, the same number being one of a predefined number, a number based upon characteristics of one of a coded and decoded representation of an image associated with the signal, a number based upon a coding mode of at least one of the plurality of transform blocks, a number dependent on an intra-prediction mode associated with at least one of the plurality of transform blocks and a number based upon shapes and sizes of motion blocks corresponding to a macroblock representative of the signal.

30. The method of claim 22, wherein the signal is one of intra prediction error and inter prediction error of the transform coefficients.

31. The method of claim 22, wherein each of the plurality of transform blocks belongs to one of a single component, different components, a single macroblock, and different macroblocks.

32. The method of claim 22, wherein the predetermined fill process comprises one of setting the remaining coefficients to zero, setting the remaining coefficients to a predefined pattern of coefficient values, and a signaled predetermined filling process.

33. The method of claim 22, wherein the signal comprises one of inter-residual data, intra-residual data, a prediction error signal, an actual video signal when no prediction is made, and an actual image signal when no prediction is made.

34. A computer program product, embodied on a computer-readable medium, comprising computer code configured to perform the processes of claim 22.

35. An apparatus, comprising:
a processor; and
a memory unit communicatively connected to the processor and including:
computer code configured to decode transform coefficients from a coded bitstream, the transform coefficients comprising a subset of transform coefficients from a plurality of transform blocks, each of the plurality of transform blocks representing a corresponding transformed portion of a signal;
computer code configured to perform inverse reorganizing and de-interleaving of the decoded transform coefficients;
computer code configured to fill remaining coefficients of each of the plurality of transform blocks according to a predetermined fill process; and
computer code configured to perform inverse quantization and inverse transformation to reconstruct a macroblock representative of the signal.

36. The apparatus of claim 35, wherein the inverse reorganizing and the de-interleaving comprises an ordering technique applied to each of the plurality of transform blocks.

37. The apparatus of claim 35, wherein the inverse reorganizing and the de-interleaving comprises a scanning technique applied to each of the plurality of transform blocks.

38. The apparatus of claim 35, wherein an order of the transform coefficients is at least one of a different order for each of the plurality of transform blocks, the order based upon characteristics of one of a coded and decoded representation of an image associated with the signal, a dependent order based upon a coding mode of at least one of the plurality of transform blocks, a dependent order based upon an intra-prediction mode associated with at least one of the plurality of transform blocks, a dependent order based upon shapes and sizes of motion blocks corresponding to a large block representative of the signal, and a signaled order.

39. The method of claim 35, wherein a same number of coefficients from each of the plurality of transform blocks is selected for encoding, the same number being one of a predefined number, a number based upon characteristics of one of a coded and decoded representation of an image associated with the signal, a number based upon a coding mode of at least one of the plurality of transform blocks, a number dependent on an intra-prediction mode associated with at least one of the plurality of transform blocks and a number based upon shapes and sizes of motion blocks corresponding to a macroblock representative of the signal.

40. The method of claim 35, where a different number of coefficients from each of the plurality of transform blocks is selected for encoding, the same number being one of a predefined number, a number based upon characteristics of one of a coded and decoded representation of an image associated with the signal, a number based upon a coding mode of at least one of the plurality of transform blocks, a number dependent on an intra-prediction mode associated with at least one of the plurality of transform blocks and a number based upon shapes and sizes of motion blocks corresponding to a macroblock representative of the signal.

41. The apparatus of claim 35, wherein each of the plurality of transform blocks belongs to one of a single component, different components, a single macroblock, and different macroblocks.

42. The apparatus of claim 35, wherein the predetermined fill process comprises one of setting the remaining coefficients to zero, setting the remaining coefficients to a predefined pattern of coefficient values, and signaling the predetermined fill process.

43. A system, comprising:
an encoder configured to perform transform coding and quantization of a signal into a plurality of transform blocks, wherein transform coefficients of the plurality of transform blocks are reorganized and interleaved into an array according to a predetermined interleaving process resulting in a subset of the transform coefficients of each of the plurality of transform blocks being encoded, quantized, and placed into a bitstream; and
a decoder configured to decode the transform coefficients from the bitstream, performing inverse reorganizing and de-interleaving of the decoded transform coefficients, filling remaining coefficients of each of the plurality of transform blocks according to a predetermined fill process, and performing inverse quantization and inverse transformation to reconstruct a macroblock representative of the signal.

44. The system of claim 43, wherein the reorganizing, the inverse reorganizing, the interleaving, and the de-interleaving comprises an ordering technique applied to each of the plurality of transform blocks.

45. The system of claim 43, wherein the reorganizing, the inverse reorganizing, the interleaving, and the de-interleaving comprises a scanning technique applied to each of the plurality of transform blocks.

46. The system of claim 43, wherein an order of the transform coefficients is at least one of a different order for each of the plurality of transform blocks, the order based upon characteristics of one of a coded and decoded representation of an image associated with the signal, a dependent order based upon a coding mode of at least one of the plurality of transform blocks, a dependent order based upon an intra-prediction mode associated with at least one of the plurality of transform blocks, a dependent order based upon shapes and sizes of motion blocks corresponding to a large block representative of the signal, and a signaled order.

47. The system of claim 43, wherein each of the plurality of transform blocks belongs to one of a single component, different components, a single macroblock, and different macroblocks.
